(19) United States
(12) Patent Application Publication
(10) Pub. No.: US 2009/0165698 A1
(43) Pub. Date: Jul. 2, 2009

(54) PORTABLE SAFETY FLAG DEVICE AND METHOD THEREFOR

(76) Inventor: Alan J. Lapkin, Las Vegas, NV (US)

Correspondence Address: WEISS & MOY PC, 4204 NORTH BROWN AVENUE, SCOTTSDALE, AZ, 85251, US

(21) Appl. No.: 11/966,066

(22) Filed: Dec. 28, 2007

(51) Int. Cl. G09F 17/00

(52) U.S. Cl. 116/173

(57) ABSTRACT

A portable safety flag device and method therefor capable of being coupled to a wheelchair, trailer or the like to improve visibility and improve safety. The portable safety flag device may include a handle at one end of a pole with a flag at the opposite end or may include a coupling mechanism, preferably a clamp, at the end of the pole opposite the flag and capable of coupling the device to a vehicle or other object.

The present application is related to U.S. Patent Application entitled “PORTABLE GOLF FLAG DEVICE AND METHOD THEREFOR”, application Ser. No. 10/372334 filed Feb. 24, 3003 (now abandoned) by the same named inventor and which is incorporated herein by reference.

### FIELD OF THE INVENTION

This invention relates generally to a safety flag and, more specifically, to a portable safety flag device capable of being held or attached to a wheelchair, trailer, bicycle, all-terrain vehicle or the like so that people can travel safely and with confidence that they and/or the objects to which the portable safety flag is attached are more visible.

### BACKGROUND OF THE INVENTION

Every year hundreds of people are injured or killed by otherwise cautious drivers that simply did not see the person, the person's wheelchair (both motorized and manual), bicycle, trailer or other vehicle in the crosswalk, parking lot, street or other locale. These tragedies are only increasing. In addition, such vehicles or other objects may be obscured during certain activities. For example, hitching a trailer to a vehicle often requires the driver exit the vehicle to determine the location of the trailer's hitch.

Accordingly there has been a need for a novel portable safety flag device which is of simplified construction, inexpensive to manufacture, capable of being held or being attached to a wheelchair, bicycle, trailer, or another vehicle or object to substantially improve visibility to save lives and prevent horrific accidents.

### BRIEF DESCRIPTION OF THE PREFERRED EMBODIMENTS

In accordance with one embodiment of the present invention, a portable safety flag device is disclosed, comprising in combination, a pole having a first end and a threaded second end for engagement with a handle and a flag coupled to the first end of the pole.

In accordance with another embodiment of the present invention, a portable safety flag assembly is disclosed, comprising in combination, a pole having a first end and a second end, a flag coupled to the first end of the pole, and a coupling mechanism adapted to couple to the second end of the pole for coupling to an object.

In accordance with another embodiment of the present invention, a portable safety flag assembly is disclosed, comprising in combination, a pole having a first end and a second end, a flag coupled to the first end of the pole, and a flexible arm adapted to couple at a first end to the second end of the pole and a clamp at the second end of the flexible arm adapted to couple to an object with or without the use of an adapter dimensioned for mounting on the object.

in accordance with another embodiment of the present invention a method for improving the visibility of an object such as a wheelchair, bicycle, trailer or the like is disclosed, comprising in combination, the steps of providing a pole having a first end and a second end, providing a flag coupled to the first end of the pole, providing one of a coupling mechanism and handle coupled to the second end of the pole, and supporting the pole in a substantially vertical position.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the portable safety flag device of the present invention, showing a flexible cable coupled to a clamp;

FIG. 2 is an assembly view of the portable safety flag of FIG. 1, showing the manner in which the flexible cable is coupled to the pole of the portable safety flag device;

FIG. 3 is a partial perspective view of one embodiment of the portable safety flag device of the present invention, showing a threaded second end of the pole which is coupled to another exemplary clamp through a ring and chain combination;

FIG. 4 is an assembly view of one embodiment of the portable safety flag device of the present invention, illustrating the manner in which a handle may be threadably engaged with the threaded second end of the pole;

FIG. 5 is a perspective view of the pole of the portable safety flag device, showing the pole telescopically extended;

FIG. 6 is a perspective view of an adapter for use with a coupling mechanism for coupling the portable safety flag device to an object;

FIG. 7 is a top view of the adapter of FIG. 6;

FIG. 8 is a side view of the adapter of FIG. 6;

FIG. 9 is a bottom view of the adapter of FIG. 6;

FIG. 10 is an assembly view, illustrating the manner in which the adapter may be mounted to an object (not shown) with an exemplary clamp coupled to the adapter; and

FIG. 11 is a perspective environmental view of one embodiment of the portable safety flag device illustrating the adapter of FIGS. 6-10 mounted to a wheelchair and having the clamp of one embodiment of the portable safety flag device coupled thereto.

### DETAILED DESCRIPTION OF THE PREFERRED EMBODIMENTS

As shown in the drawings for purposes of illustration, the present invention is concerned with an improved portable safety flag assembly generally designated in the accompanying drawings by the reference number 10. The portable safety flag assembly comprises, generally, a pole 12 having a first end and a second end 14 and 16, a flag 18 coupled to the first end of the pole, and one of a handle 20 and clamp 22a or 22b adapted to engage with the second end of the pole to support the pole in a substantially vertical position. The portable safety flag assembly may further comprise an adapter 24 dimensioned for mounting on an object for coupling the clamp 22a thereto.

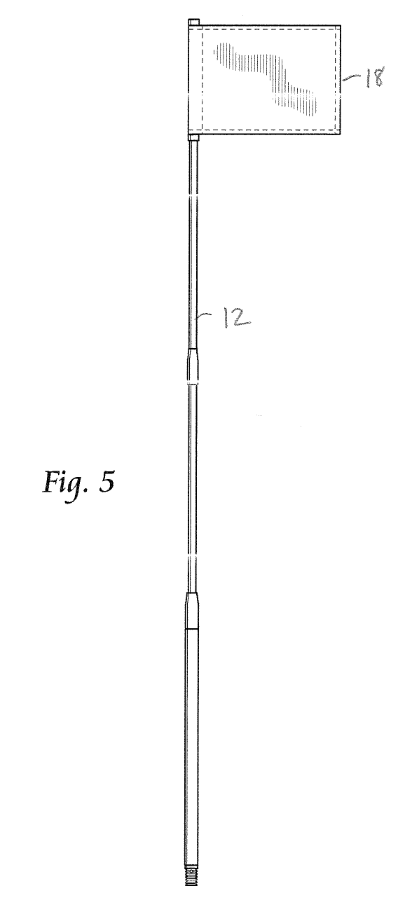

The pole 12 may be a one piece or multi-piece pole or the like constructed of a substantially flexible fiberglass, metal, composite, or other flexible material as known in the art that permits bending without breaking. The pole may be telescoping in order to adjust its length (See FIG. 5).

The flag 18 may be a tear and weather proof high-visibility flag or the like. The flag may include designs, text or the like which may additionally provide warning messages.

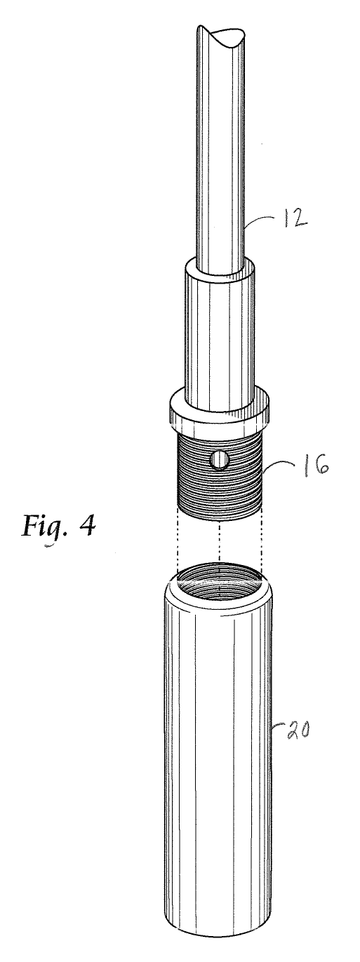

As shown in FIG. 4, one embodiment of the portable safety flag device 10 includes the handle 20. The handle permits a person to hold the pole 12 in an upright position. This enables the person to mark his or her position, particularly useful for golfers and fly fishermen. The handle also permits flag waving to cheer on a favorite team. Preferably, the second end 16 of the pole 12 is threaded and the first end of the handle 20 is threaded and dimensioned to be coupled to the threaded second end 16 of the pole 12, although it should be clearly understood that substantial benefit could be derived from an alternative means of coupling the first end of the handle to the second end 16 of the pole 12.

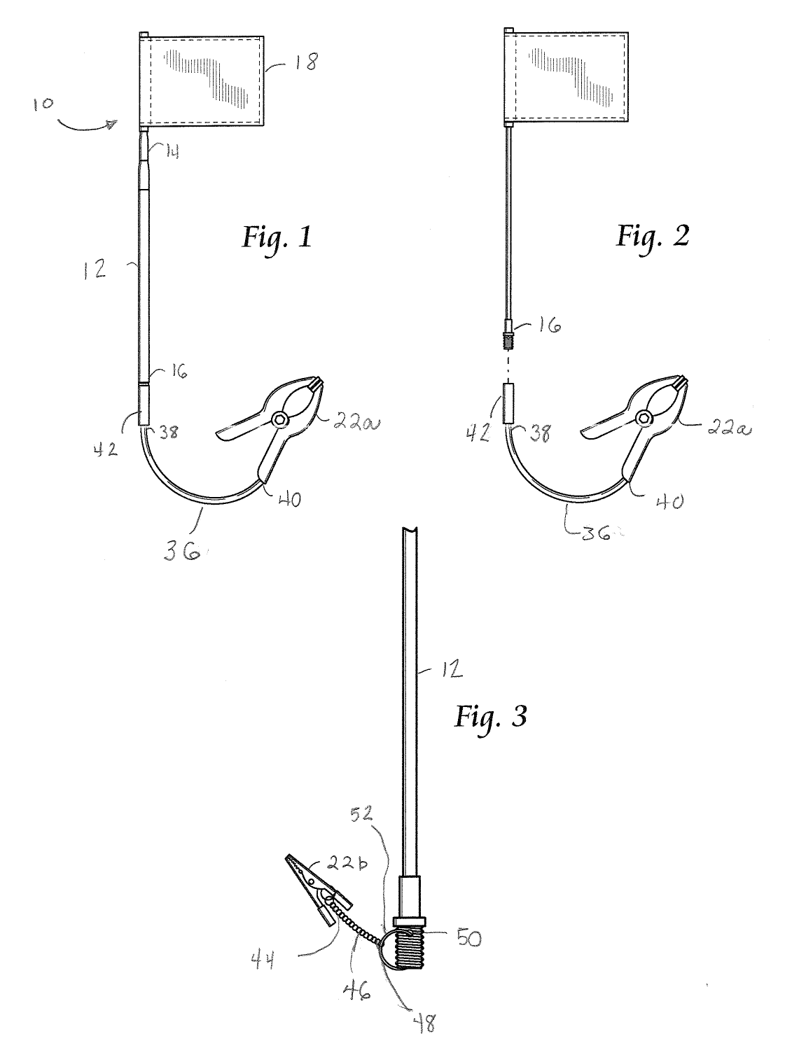

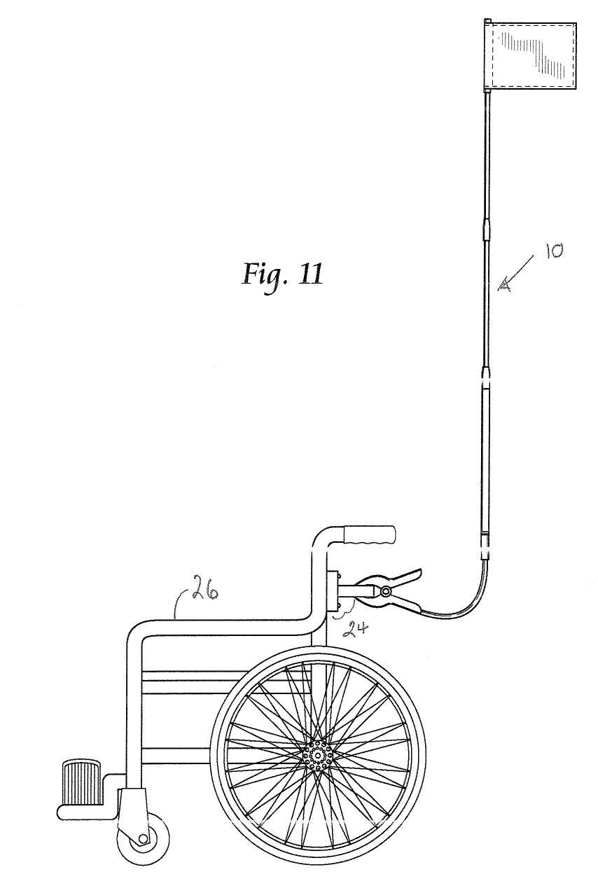

As shown in FIGS. 1-2, one embodiment of the portable safety flag device 10 comprises a clamp 22a as the coupling mechanism 20. Preferably, the clamp 22a is a heavy-duty-type spring-biased clamp capable of clamping onto an object, such as a wheelchair (identified in FIG. 11 as 26), trailer, stroller or the like, while at the same time supporting the pole 12 in a substantially vertical, upright position. It should be clearly understood, however, that substantial benefit could be derived from an alternative configuration of the coupling mechanism 22a or 22b in which a device other than a clamp 20a is used, so long as it is capable of coupling the pole 12 securely to an object in a substantially vertical position. It should also be clearly understood that the portable safety flag may also be mounted in a horizontal position which may be advantageous, for example, in areas where there may not be sidewalks—drivers will be forced to make a wider path around the wheelchair, trailer or the like to avoid getting too close.

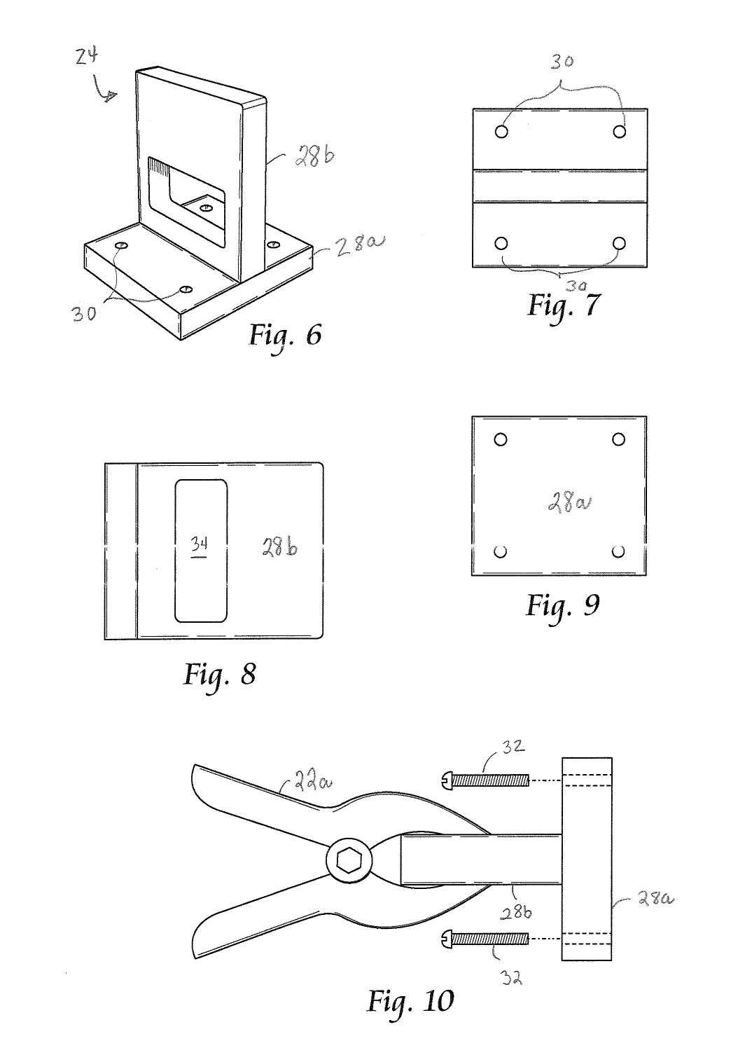

The adapter 24 (FIGS. 6-10) may be used with the clamp 22a to permit the clamp to be used on most wheelchairs, bicycles, trailers, strollers or the like as well as other surfaces. In a preferred embodiment as shown in FIGS. 6- 10, the adapter 24 has a generally T-shaped configuration with a generally rectangular base portion 28a and a wall portion 28b that extends about 90 degrees upwardly therefrom. The base portion provides the mounting surface against the wheelchair, bicycle, trailer, stroller or the like. A plurality of openings 30 may be provided in the base portion 28a to receive a plurality of fasteners 32 such as bolts, screws or the like (See FIG. 10) to mount the adapter to the object. Alternatively, the base portion 28a may be mounted to the object by double-sided tape (not shown) or the like placed on the bottom surface of the adapter. The wall portion 28b has a substantially rectangular opening 34 therein to provide a clamping surface with the nose of the clamp 22a secured within the opening as shown in FIG. 10. FIG. 11 shows the adapter 24 mounted to the framework of a wheelchair 26 with the clamp 22a coupled thereto.

As shown in FIGS. 1 and 2, in one embodiment, the portable safety flag device 10 further comprises a flexible cable 36 having a first end 38 and a second end 40. The first end 38 of the flexible cable 36 is coupled to the second end 16 of the pole 12. The second end 40 of the flexible cable 36 is coupled to the clamp 22a. Preferably, the clamp 22a and the flexible cable 36 are fixedly coupled to one another, forming a one-piece assembly, although it should be clearly understood that substantial benefit could be derived from an alternative embodiment of the present invention in which the second end 40 of the flexible cable 36 is detachably coupled to the clamp 22a. The flexible cable 36 preferably has sufficient flexibility to be bent between the first end 38 and the second end 40 while at the same time the flexible cable 36 has sufficient rigidity to remain in a fixed position after the flexible cable 36 is bent. Preferably, the second end 16 of the pole 12 is threaded and the first end 38 of the flexible cable 36 defines a threaded sleeve 42 dimensioned to be coupled to the threaded second end 16 of the pole 12, although it should be clearly understood that substantial benefit could be derived from an alternative means of coupling the first end 38 of the flexible cable 36 to the second end 16 of the pole 12, such as a spring-biased ball detent, so long as the flexible cable 36 is securely coupled to the pole 12.

Referring now to FIG. 3, an alternative clamp (hereinafter “gripper”) 22b is shown. The gripper 22b is preferably coupled to a first end 44 of a chain 46. A second end 48 of the chain 46 is coupled preferably to the second end 16 of the pole 12. Preferably, the second end 48 of the chain 46 is coupled to the second end 16 of the pole 12 through an aperture 50 defined by the second end 16 of the pole 12. In one embodiment, shown in FIG. 3 a ring 52 is coupled to the second end 16 of the pole 12 through the aperture 50 and the second end 48 of the chain 46 is coupled to the ring 52, although it should be clearly understood that substantial benefit could be derived from an alternative embodiment of the portable safety flag device 10 in which there is no ring 52, or in which the gripper 22b is coupled to the second end 16 of the pole 12 without a chain 46, so long as the gripper 22b is capable of being securely coupled to the pole 12. The gripper 22b is designed to couple the pole 12 to an object in which it is not necessary for the pole 12 to be held in an upright position.

From the foregoing, it is to be appreciated that the safety flag device may be held securely or mounted quickly, easily, and securely on most wheelchairs, bicycles, trailers and the like and in a variety of positions. The height of the flag may be instantly adjustable. The flag can be quickly repositioned for use in either a vertical or horizontal position. The portable safety flag may be useful for substantially all low-profile vehicles where their visibility may be otherwise compromised. For example, during trailer hitching, the portable safety flag may be attached to the front of the trailer hitch to notify the driver of the towing vehicle of its position. It may also be coupled to a bicycle to warn vehicles. The improved visibility provided by the portable safety flag device also helps in other situations. The portable safety flag device may also serve as a beacon to help those lost. In addition, the flag may provide a warning to, for example, bed-ridden patients or those confined to beds that movement therefrom could be injurious.

While the invention has been particularly shown and described with reference to preferred embodiments thereof, it will be understood by those skilled in the art that the foregoing and other changes in form and details may be made therein without departing from the spirit and scope of the invention.

I claim:

1. A portable safety flag device comprising, in combination:
a pole having a first end and a second end,
a flag coupled to the first end of the pole; and
means for engaging the second end of the pole for maintaining the portable safety flag device in a substantially vertical position.

2. The portable safety flag device of claim 1, wherein said engagement means comprises a coupling mechanism.

3. The portable safety flag device of claim 2, wherein the coupling mechanism is a clamp.

4. The portable safety flag device of claim 3, wherein the clamp being spring-biased.

5. The portable safety flag device of claim 3, wherein the engagement means further comprises a flexible cable having a first end and a second end, the first end of the flexible cable being coupled to the second end of the pole and the second end of the flexible cable being coupled to the clamp, the flexible cable having sufficient flexibility to be bent between the first end and the second end while at the same time the flexible cable having sufficient rigidity to remain in a fixed position after the flexible cable is bent.

6. The portable safety flag device of claim 5 wherein the second end of the pole being threaded and the first end of the flexible cable defining a threaded sleeve dimensioned to be coupled to the threaded second end of the pole.

7. The portable safety flag device of claim 4, wherein the coupling mechanism further comprises an adapter dimensioned for coupling the clamp to an object, wherein the adapter has substantially a T-shaped configuration comprised of a base portion adapted to be mounted to the object and a wall portion having an opening therein adapted to provide a clamping surface therethrough.

8. The portable safety flag device of claim 4, further comprising a chain having a first end and a second end, the first end of the chain being coupled to the second end of the pole and the second end of the chain being coupled to the clamp.

9. The portable safety flag device of claim 1, wherein the engagement means comprises a handle threadably engaged with the second end of the pole.

10. A method for substantially improving the visibility of a person, vehicle or other object comprising, in combination, the steps of:
providing a pole having a first end and a second end;
providing a flag coupled to the first end of the pole; and
providing engagement means at the second end of the pole; and
supporting the pole in a substantially vertical position.

11. The method of claim 10, wherein the engagement means comprises a coupling mechanism and the method further comprises the step of coupling the coupling mechanism to an object to support the pole in a substantially vertical position.

12. The method of claim 11 wherein the coupling mechanism is a clamp.

13. The method of claim 12 wherein the clamp being spring-biased.

14. The method of claim 13 further comprising the steps of:
providing a flexible cable having a first end and a second end; and
coupling the first end of the flexible cable to the second end of the pole, the second end of the flexible cable being coupled to the clamp, the flexible cable has sufficient rigidity to remain in a fixed position after the flexible cable is bent.

15. The method of claim 14 wherein the second end of the pole being threaded and the first end of the flexible cable defining a threaded sleeve dimensioned to be coupled to the threaded second end of the pole.

16. The method of claim 11 further comprising the steps of:
providing a chain having a first end and a second end;
coupling the first end of the chain to the second end of the pole; and
coupling the second end of the chain to the clamp.

17. The method of claim 17 further comprising the step of coupling the first end of the chain to the second end of the pole through an aperture defined by the second end of the pole.
